(19) United States
(12) Patent Application Publication
(10) Pub. No.: US 2015/0052465 A1
(43) Pub. Date: Feb. 19, 2015

(54) Feedback for Lasso Selection

(71) Applicant: Microsoft Corporation, Redmond, WA (US)

(72) Inventors: Daniel John Altin, South San Francisco, CA (US); Sarah Morgan Ferraro, Mountain View, CA (US)

(73) Assignee: Microsoft Corporation, Redmond, WA (US)

(21) Appl. No.: 13/969,091

(22) Filed: Aug. 16, 2013

(51) Int. Cl. G06F 3/0486; G06F 3/0484

(52) U.S. Cl. CPC G06F 3/0486; G06F 3/04842
USPC 715/769; 715/822

(57) ABSTRACT

Visual feedback indicating that a graphical element is included in a selection boundary prior to a commitment of a selection is provided. Visual feedback may be displayed indicating which graphical element(s) may be selected once a lasso selection operation is completed. That is, the visual feedback is provided while the selection is being made. Accordingly, a user may be able to see, prior to commitment of the selection, which graphical elements may be selected. The visual feedback may include various visual indications, such as providing a border or highlighting around selected graphical elements, shading or coloring selected graphical elements, animating selected graphical elements, providing an indication of a number of selected graphical elements, providing an indication of progressive disclosure of selection of a graphical element, or providing an indication of a graphical element's bounding box.

### BACKGROUND

Modern day users use various software applications to perform a variety of tasks, for example, to write, calculate, draw, organize, prepare presentations, send and receive electronic mail, make music, and the like. Oftentimes, users may wish to select one or more displayed graphical elements in a document. Many applications provide a functionality for enabling a user to draw a selection boundary around the graphical element(s) he/she wishes to select. Sometimes referred to as a lasso selection functionality, a user may click/touch on a user interface (UI), and drag a lasso or selection boundary around the graphical element(s). When the user releases the click/touch, a visual of the selected graphical elements that have been selected may be displayed.

While current graphical element selection via a click/touch and drag operation (herein referred to as a lasso selection) has many advantages, it may not be clear to a user as to which graphical elements may fall into the selection bounds. That is, until a selection operation is completed, the user may not know for certain which graphical elements he/she has selected. For example, a graphical element that a user thinks he/she may have selected may not be selected, and the user may not be aware of the non-selected graphical element until after the user completes the selection. Additionally, oftentimes in the case of when partial selection of graphical elements is enabled, a user may not be aware that he/she is selecting graphical elements that he/she may not wish to select; he/she may not be aware of the unintentionally selected graphical element until after he/she completes the selection.

It is with respect to these and other considerations that the present invention has been made.

### SUMMARY

This summary is provided to introduce a selection of concepts in a simplified form that are further described below in the detailed description. This summary is not intended to identify key features or essential features of the claimed subject matter, nor is it intended as an aid in determining the scope of the claimed subject matter.

Embodiments of the present invention solve the above and other problems by providing visual feedback indicating that a graphical element is included in a selection boundary prior to a commitment of a selection. The visual feedback may include various visual indications. For example, the visual feedback may include providing a border or highlighting around selected graphical elements, shading or coloring selected graphical elements, animating selected graphical elements, providing an indication of a number of selected graphical elements, providing an indication of progressive disclosure of selection of a graphical element, providing an indication of a graphical element's bounding box, etc.

The details of one or more embodiments are set forth in the accompanying drawings and description below. Other features and advantages will be apparent from a reading of the following detailed description and a review of the associated drawings. It is to be understood that the following detailed description is explanatory only and is not restrictive of the invention as claimed.

### BRIEF DESCRIPTION OF THE DRAWINGS

The accompanying drawings, which are incorporated in and constitute a part of this disclosure, illustrate various embodiments of the present invention. In the drawings:

FIG. 1 is a block diagram of one embodiment of a system for providing visual feedback indicating that a graphical element is included in a selection boundary prior to a commitment of a selection;

FIGS. 2A, 2B, and 2C are example illustrations of selection of graphical elements without providing an indication of a selection boundary prior to a commitment of the selection;

FIG. 3 is an example illustration of providing visual feedback indicating that a graphical element is included in a selection boundary prior to a commitment of the selection;

FIGS. 4A and 4B are example illustrations of selection of graphical elements without providing an indication of a selection boundary prior to a commitment of the selection;

FIG. 4C is an example illustration of providing visual feedback indicating that a graphical element is included in a selection boundary prior to a commitment of a selection via animation and an indication of a number of selected graphical elements according to an embodiment;

FIG. 4D is an example illustration of providing visual feedback indicating that a graphical element is included in a selection boundary prior to a commitment of a selection and a group indication indicating which graphical elements belong to a group;

FIG. 5A is an example illustration of providing visual feedback indicating that a graphical element is included in a selection boundary prior to a commitment of a selection via progressive disclosure of the selection according to an embodiment;

FIG. 5B is an example illustration of providing visual feedback indicating that a graphical element is included in a selection boundary prior to a commitment of a selection and including an indication of a graphical element's bounding box according to an embodiment;

FIG. 6 a flow chart of a method for providing visual feedback indicating that a graphical element is included in a selection boundary prior to a commitment of a selection;

FIG. 7 is a block diagram illustrating example physical components of a computing device with which embodiments of the invention may be practiced;

FIGS. 8A and 8B are simplified block diagrams of a mobile computing device with which embodiments of the present invention may be practiced; and

FIG. 9 is a simplified block diagram of a distributed computing system in which embodiments of the present invention may be practiced.

### DETAILED DESCRIPTION

As briefly described above, embodiments of the present invention are directed to providing visual feedback indicating that a graphical element is included in a selection boundary prior to a commitment of a selection. The following detailed description refers to the accompanying drawings. Wherever possible, the same reference numbers are used in the drawing and the following description to refer to the same or similar elements. While embodiments of the invention may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the invention, but instead, the proper scope of the invention is defined by the appended claims.

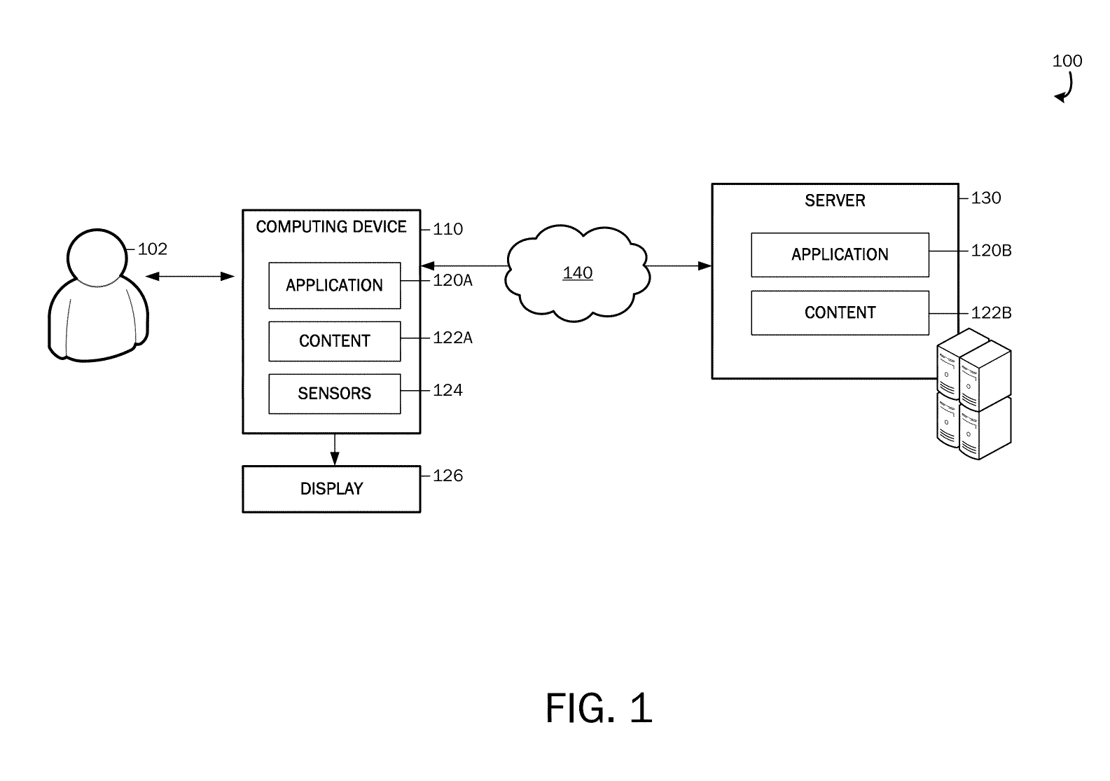

Referring now to the drawings, in which like numerals represent like elements, various embodiments will be described. FIG. 1 is a block diagram illustrating a system architecture 100 for providing visual feedback indicating that a graphical element is included in a selection boundary prior to a commitment of a selection in accordance with various embodiments. The system architecture 100 includes a computing device 110. The computing device 110 may be one of various types of computing devices (e.g., a tablet computing device, a desktop computer, a mobile communication device, a laptop computer, a laptop/tablet hybrid computing device, a large screen multi-touch display, a gaming device, a smart television, or other types of computing devices) for executing applications 120 for performing a variety of tasks.

A user 102 may utilize an application 120 on a computing device 110 for a variety of tasks, which may include, for example, to write, calculate, draw, organize, prepare presentations, send and receive electronic mail, take and organize notes, make music, and the like. Applications 120 may include thick client applications 120A, which may be stored locally on the computing device 110, or may include thin client applications 120B (i.e., web applications) that may reside on a remote server 130 and accessible over a network 140, such as the Internet or an intranet. A thin client application may be hosted in a browser-controlled environment or coded in a browser-supported language and reliant on a common web browser to render the application executable on a computing device 110.

The computing device 110 may be configured to receive content 122 for presentation on a display 126 (which may comprise a touch screen display). For example, content 122 may include a document comprising one or more displayed graphical elements.

An application 120 may be configured to enable a user 102 to use a pointing device (e.g., a mouse, pen/stylus, etc.) and/or to utilize sensors 124 (e.g., touch sensor, accelerometer, hover, facial recognition, voice recognition, light sensor, proximity sensor, gyroscope, tilt sensor, GPS, etc.) on the computing device 110 to interact with content 122 via a number of input modes. To assist users to locate and utilize functionalities of a given application 120, a user interface (UI) containing a plurality of selectable functionality controls may be provided.

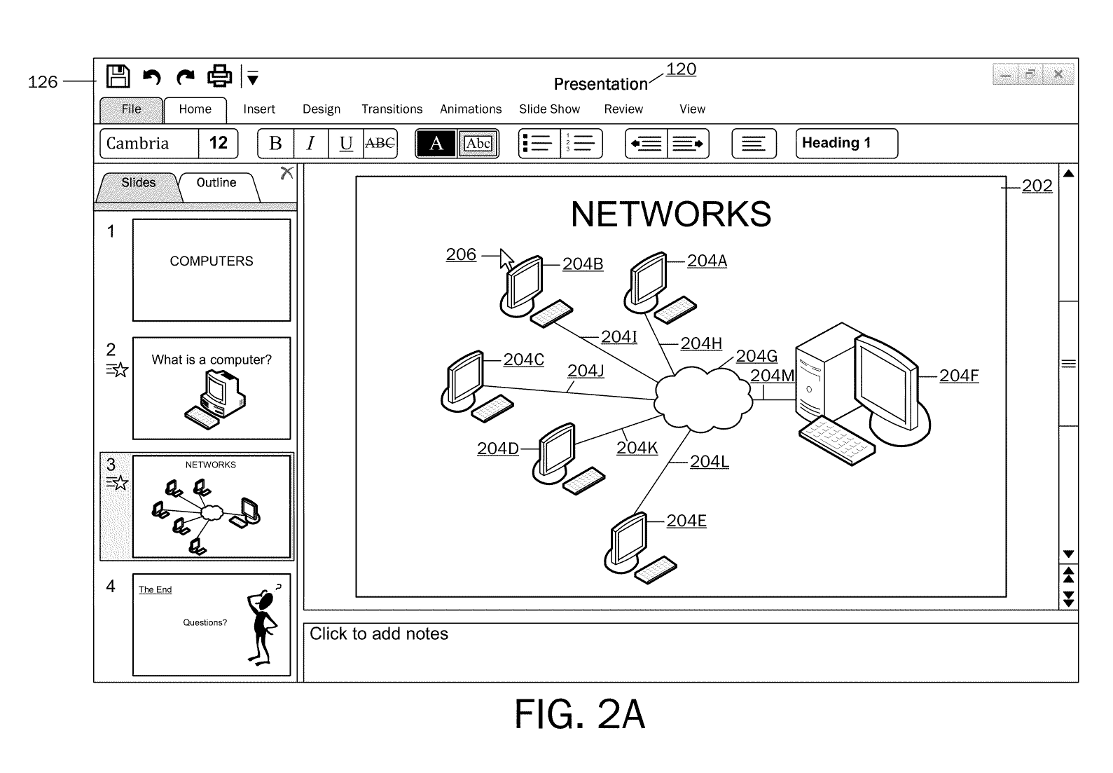

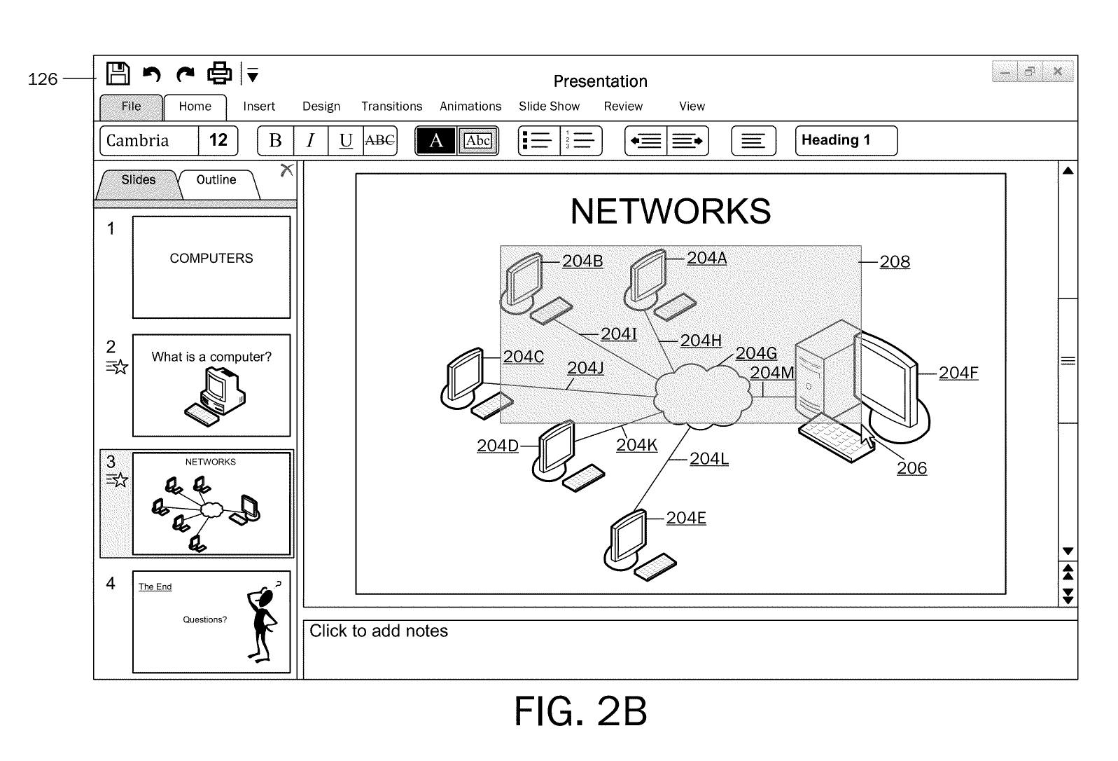

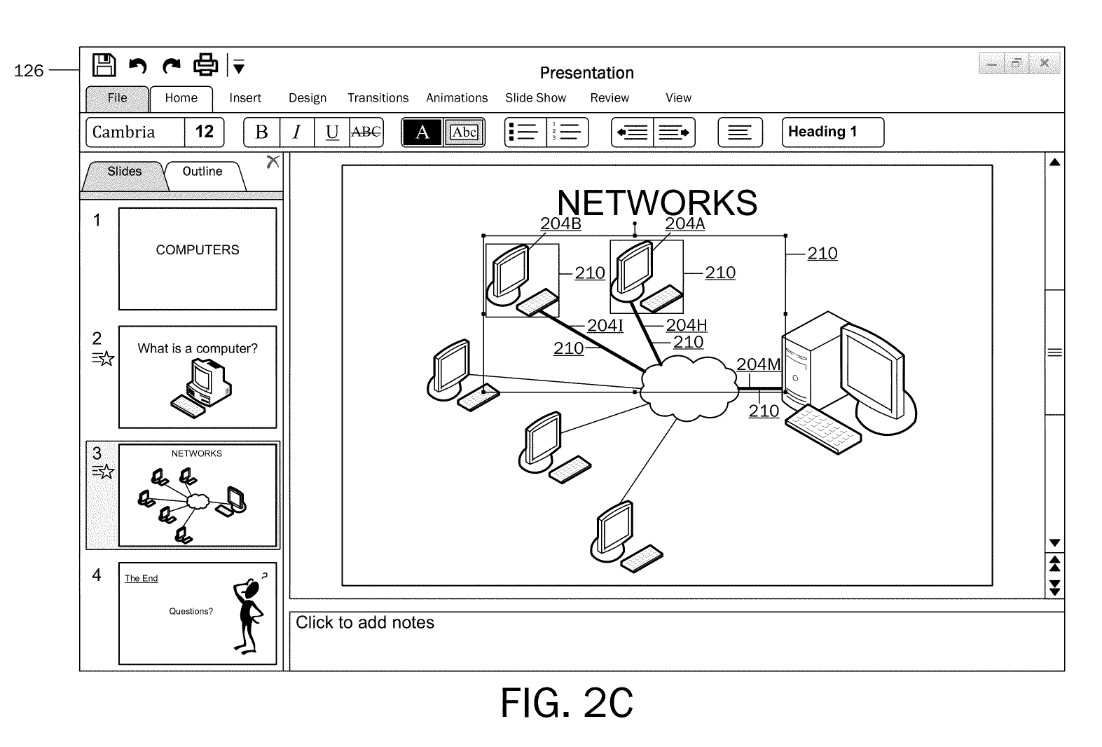

Referring now to FIG. 2A, an example illustration of a document 202 comprising a plurality of graphical elements 204 is shown displayed in a UI of an application 120. In this example, the application 120 is a slide presentation application. A user 102 may wish to select one or more graphical elements 204 in the document 202. To initiate a selection operation, the user 102 may move a cursor 206 by utilizing a pointing device, in this example a mouse, and click on a location in the UI from which to start a lasso selection.

According to embodiments and as used herein, the term lasso selection may be utilized to describe area selection and freeform selection. For example, with area selection, after the user 102 clicks on a location in the UI from which to start a lasso selection, the user 102 may perform a drag gesture moving the cursor 206 over the graphical elements 204 he/she wishes to select. Accordingly, and as illustrated in FIG. 2B, a selection boundary 208 indicative of the selection bounds may be displayed starting at the initial lasso selection location and becoming enlarged as the drag gesture moves further away from the initial lasso selection location. With freeform selection, after the user 102 clicks on a location in the UI from which to start a lasso selection, he/she may trace around the graphical element(s) 204 he/she wishes to select.

The example illustrated in FIG. 2B is an example of what may be displayed prior to embodiments of the present invention. As can be seen, no visual feedback may be provided of what graphical elements 204 may be selected when the user 102 completes the lasso selection. For example, the user 102 may think that he/she is selecting graphical elements 204A, 204B, 204C, 204G, 204H, 204I, 204J, and 204M; however, as illustrated by the selection indicators 210 in FIG. 2C, the graphical elements 204 included in the selection bounds (selection boundary 208) may not include graphical element 204G. The user 102 may become aware of this after he/she has completed the selection operation. Accordingly, he/she may have to dismiss the selection and retry the lasso selection to include all the graphical elements 204 he/she is trying to select.

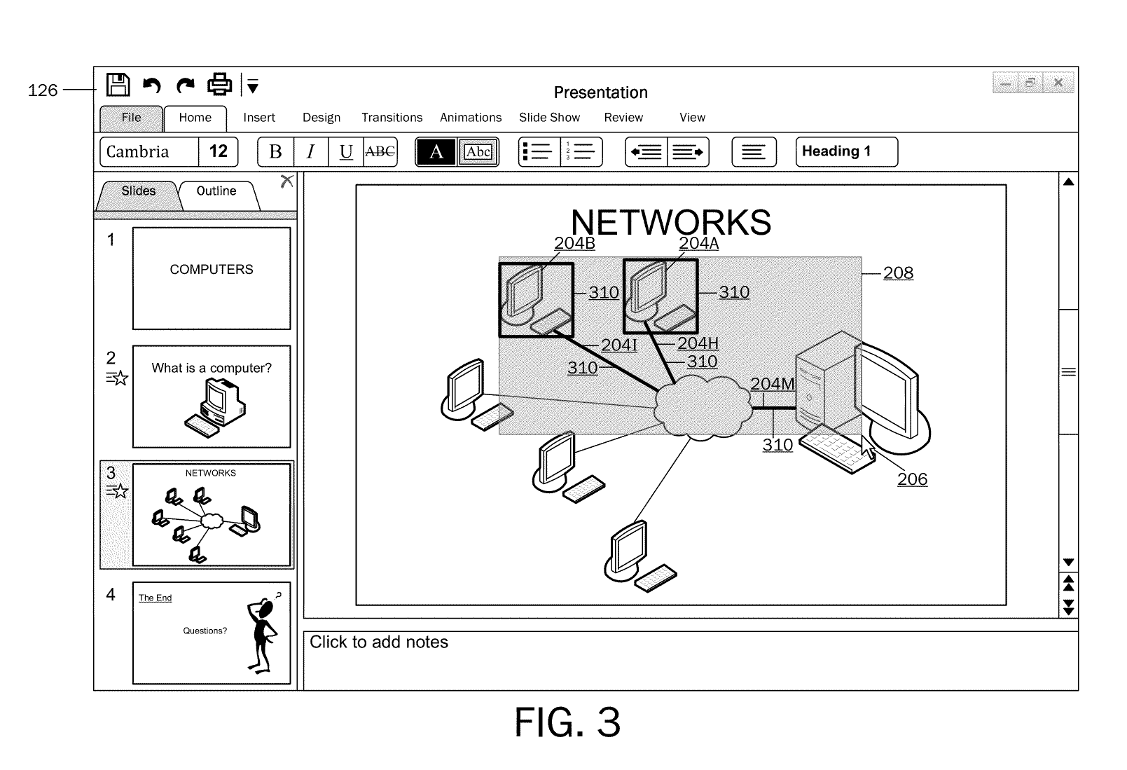

Referring now to FIG. 3, visual feedback 310 of selection of a graphical element 204 prior to commitment of the selection according to embodiments is illustrated. As briefly described above, embodiments provide for displaying visual feedback 310 indicating which graphical element(s) 204 are included in the selection bounds (selection boundary 208) and will be selected upon commitment of the selection. The example illustrated in FIG. 3 shows a selection boundary 208 displayed as the user 102 is making a lasso selection of graphical elements 204. Although alternative selection options may be provided, in this example, a selection boundary 208 may need to completely encompass a graphical element 204 for it to be selected. As illustrated and according to embodiments, during the lasso selection operation, visual feedback 310 may be provided to indicate that graphical elements 204A, 204B, 204H, 204I, and 204M will be selected upon commitment of the selection. Accordingly, the user 102 may not be unclear or confused about what will be included in the selection and what will not.

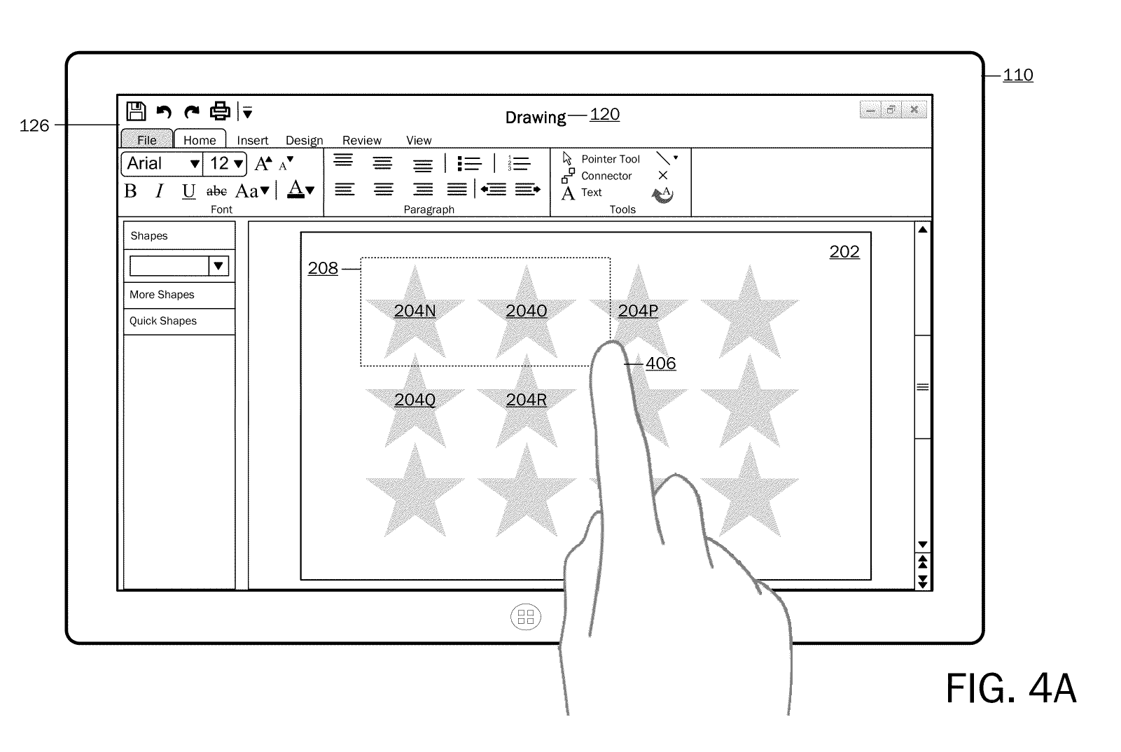

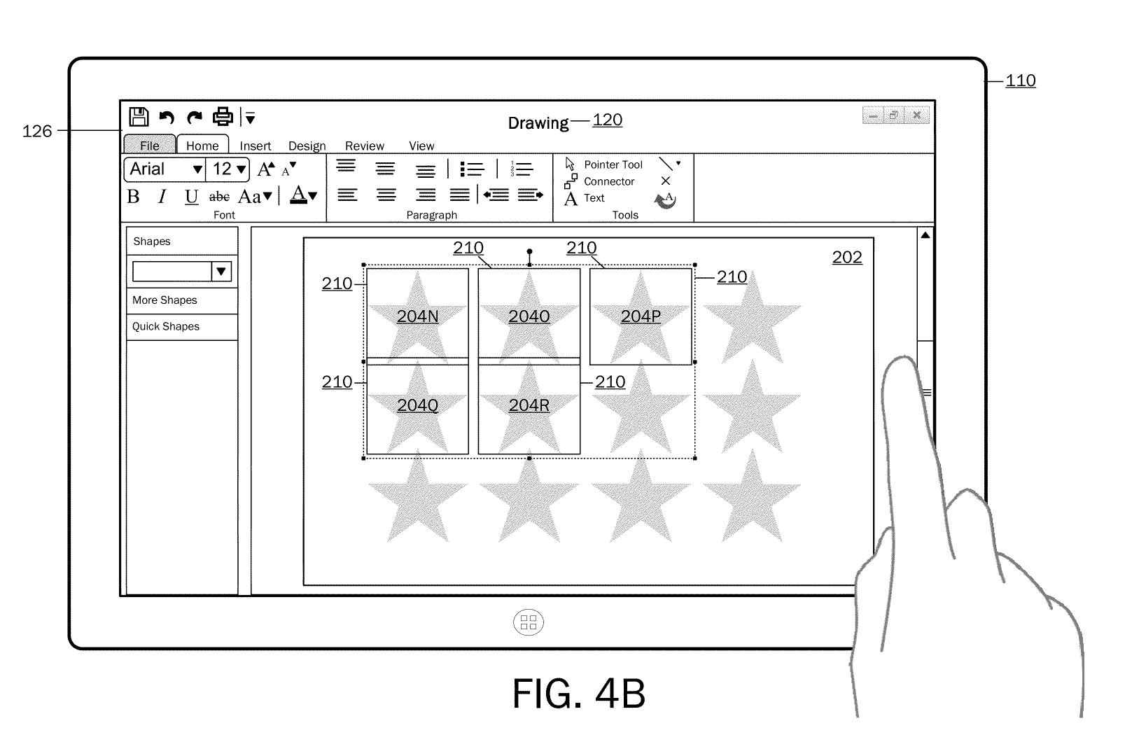

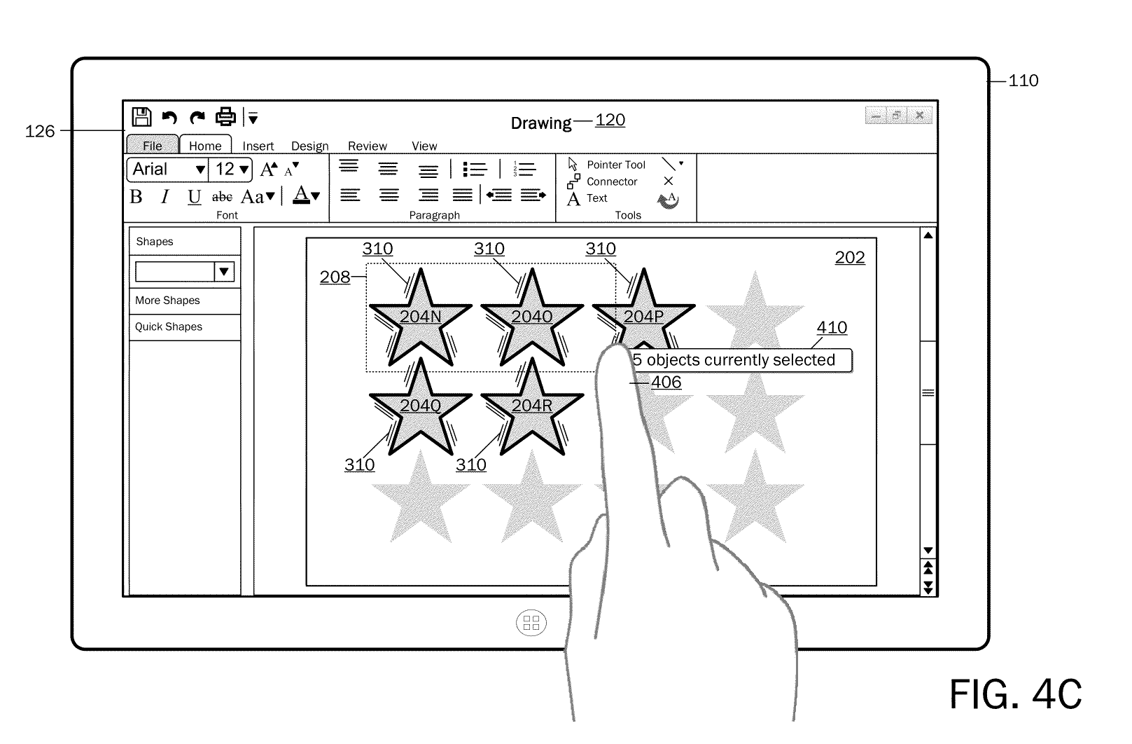

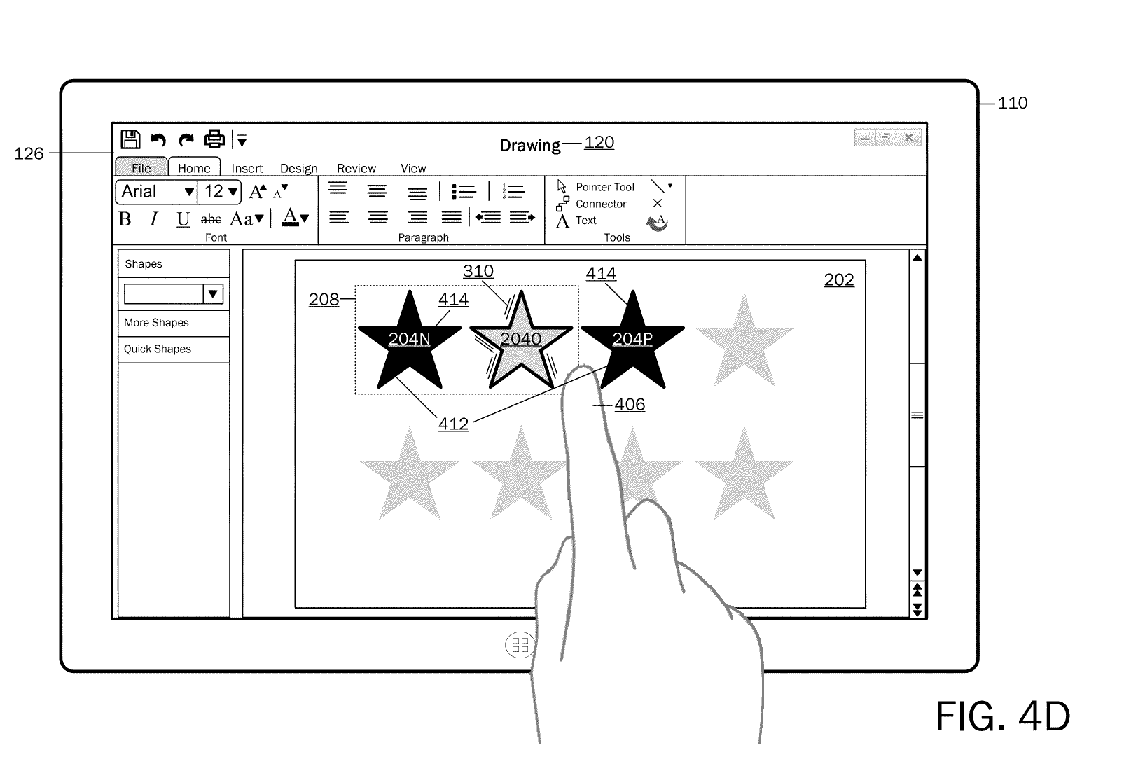

Referring now to FIG. 4A, a computing device 110 (in this illustration, a tablet computing device) is shown with an example document 202 comprising a plurality of graphical elements 204 displayed in a UI of an application 120. In this example, the application 120 is a drawing application. A display surface 126 of the computing device 110 may be a touchscreen 402, which may be operable to enable a user 102 to interact with content 122 via touch input. The user 102 may wish to select one or more graphical elements 204 in the document 202. To initiate a selection operation, the user 102 may touch 406 on a location in the UI from which to start a lasso selection, and drag his finger (or other touch device) across the display surface 126 to perform a lasso selection of graphical elements 204.

Although alternative selection options may be provided, in this example, a graphical element 204 may be selected if it is partially within a selection boundary 208. That is, the selection boundary 208 may not need to completely encompass a graphical element 204 for it to be selected. Consider, for example, that the user 102 may wish to select graphical elements 204N and 2040; however, as he/she is performing the lasso selection operation, the selection boundary 208 may partially cover other graphical elements (e.g., graphical elements 204P, 204Q, and 204R).

The example illustrated in FIG. 4A is an example of what may be displayed prior to embodiments of the present invention. As can be seen, no visual feedback may be provided of what graphical elements 204 may be selected when the user 102 completes the lasso selection. The user 102 may not be aware that graphical elements 204 may be selected with partially selected, or may not be aware that other graphical elements 204P, 204Q, and 204R are partially selected. Accordingly, when the user 102 releases the touch and consequently completes the lasso selection, he/she may then become aware of which graphical elements 204N-204R have been selected as illustrated in FIG. 4B. Considering that he/she had only intended to select graphical elements 204N and 204O, the user may have to dismiss the selection and retry the lasso selection to include only the graphical elements 204 he/she wishes to select.

Referring now to FIG. 4C, visual feedback 310 of selection of a graphical elements 204N-R prior to commitment of the selection according to embodiments is illustrated. In the example illustrated in FIG. 4C, the visual feedback 310 may include animation of the graphical elements 204N-R that are included within the selection bounds (selection boundary 208) that will be selected upon commitment of the selection. For example, the graphical elements 204N-R may be displayed as wiggling, flashing, etc. Accordingly, the user 102 may not be unclear or confused about what will be included in the selection and what will not prior to completing the selection, and may be able to make any necessary adjustments to the selection area so that he/she can select only the graphical elements 204N, 204O he/she wishes to select.

According to embodiments, other types of visual feedback 310 may be provided. For example and as illustrated in FIG. 4C, a text notification 410 indicating a number of graphical elements 204 that will be selected upon commitment of the lasso selection may be displayed. The user 102, knowing that he/she only intends to select two graphical elements 204N, 204O may see the text notification 410 indicating that there are five graphical elements 204N-R that will be selected upon commitment of the lasso selection, and be alerted to the fact that he/she is unintentionally selecting other graphical elements 204P, 204Q, 204R.

Sometimes a plurality of graphical elements 204 may be combined into a group 412. When graphical elements are combined into a group 412, the group 412 may be treated as a single element. When a user tries to perform a lasso selection around a graphical element 204 that belongs to a group 412, the graphical element 204 may not be selected if he/she does not capture all the graphical elements 204 in the group 412. Alternatively, in a case where partial selection is allowed, he/she may perform a lasso selection around a graphical element 204, and not realizing that it belongs to a group 412, the whole group 412 may be unintentionally selected.

FIG. 4D shows an example of a user 102 trying to select two graphical elements 204N and 204O via a lasso selection, but where one of the graphical elements 204N belongs to a group 412 comprised of graphical elements 204N and 204P. In this example, the user 102 may not be aware of which graphical elements 204 belong to the group 412. If selection settings are set such that a graphical element 204 must be completely encompassed for it to be selected, the user 102 may not be aware that the graphical element 204N is part of a group 412, try to select a graphical element 204N of a group 412, and may not understand why it is not being selected. Alternatively, he/she may be aware of the group 412; however, he/she may not know exactly of which graphical elements 204N,P the group 412 is comprised. For example, the user 102 may try to perform a selection of a plurality of graphical elements 204 thinking that he/she has selected all the graphical elements 204 in the group 412; however, if he/she has not captured all the graphical elements 204 in the group 412, the graphical elements 204 in the selection boundary 208 may not be selected.

Providing visual feedback 310 of selection of graphical elements 204 prior to commitment of the selection may help the user 102 to determine which graphical elements 204 belong to a group 412, and/or when all graphical elements 204 in a group are within a selection boundary 208. According to an embodiment and as illustrated in FIG. 4D, an indication of which graphical elements 204 a group 412 is comprised (herein referred to as a group indication 414) may be displayed. For example, graphical elements 204N and 204P may be combined into a group 412. The user 102 may perform a lasso selection of graphical elements 204N and 204O; however, as illustrated, visual feedback 310 (e.g., animation) may only be displayed for graphical element 204O since graphical element 204N is part of a group 412, and all graphical elements 204 in the group 412 are not included in the selection boundary 208.

As described, a group indication 414 may be provided. In the example illustrated in FIG. 4D, the group indication 414 may be displayed as a highlighting or shading of the graphical elements 204N, 204P belonging to the group 412. As should be appreciated, an indication of a group (i.e., group indication 414) may be displayed in a variety of ways. By providing a group indication 414, a user 102 may be better able to select the graphical elements 204 that he/she wishes to select.

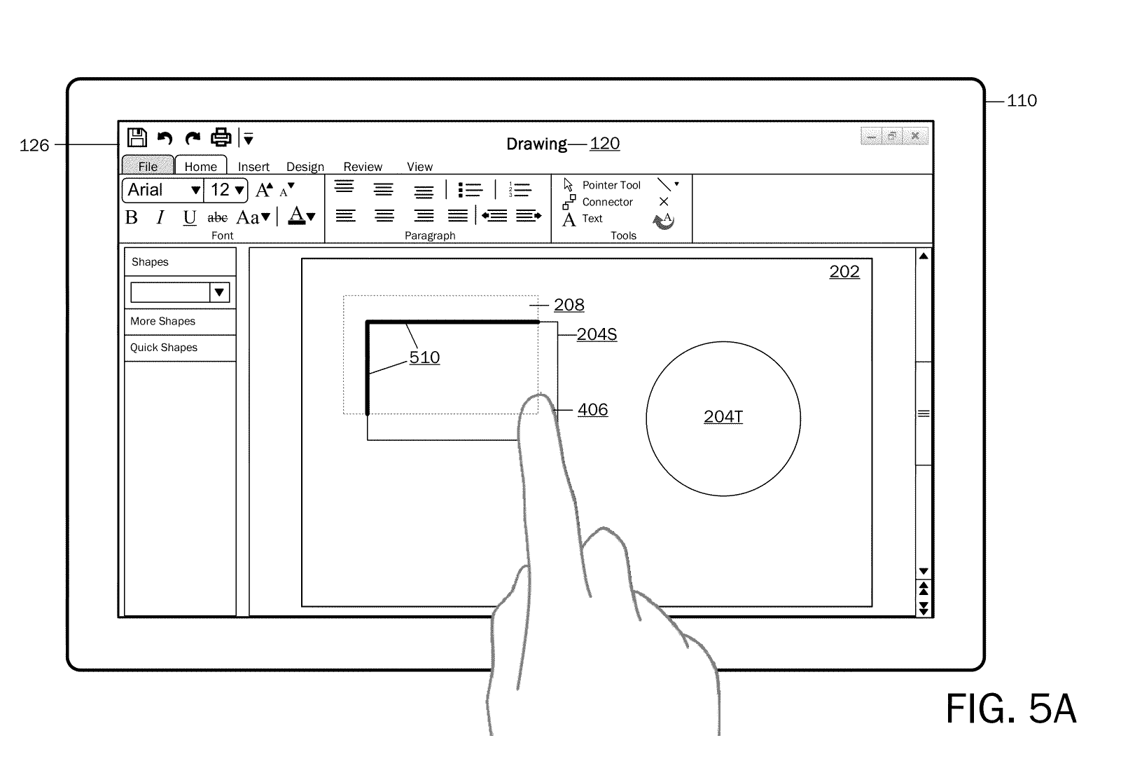

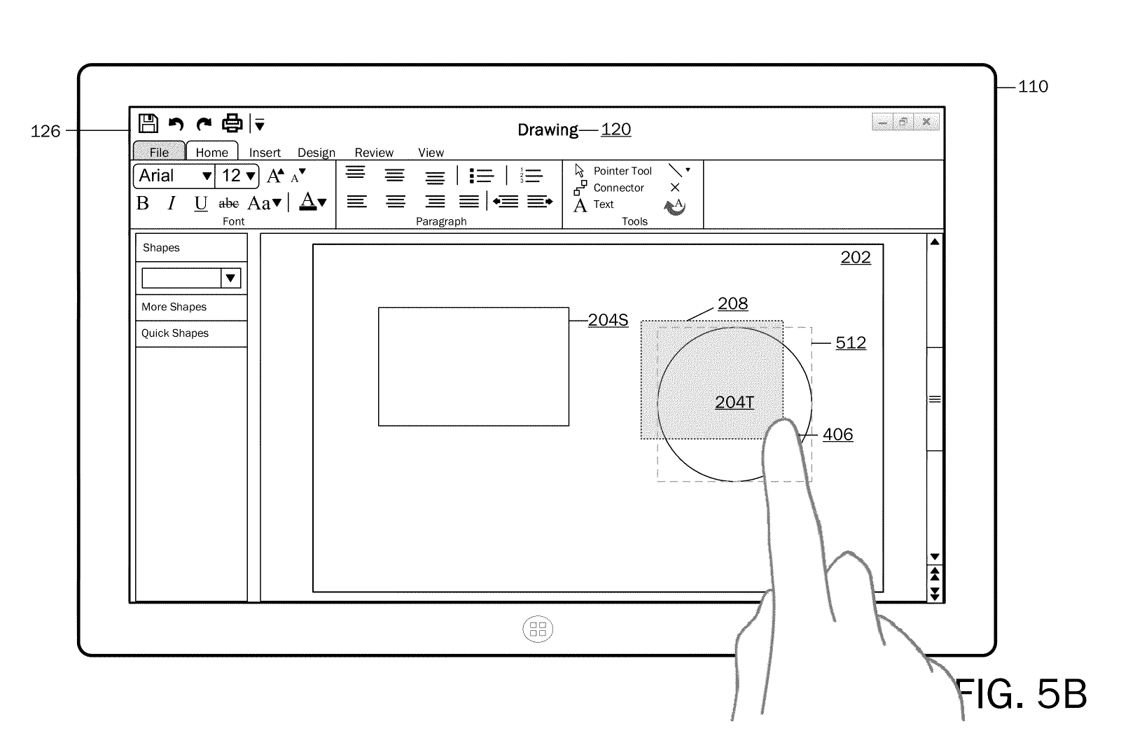

According to embodiments, progressive visual feedback disclosure may be provided. As a user 102 is performing a lasso selection of a graphical element 204S, for example and as illustrated in FIG. 5A as a touch 406 and drag gesture over a graphical element 204S, progressive feedback 510 may be provided. The progressive feedback 510 may include visual feedback to the user 102 as to what portion of a graphical element 204S is currently included in the selection bounds (selection boundary 208). When selection settings are set such that a graphical element 204 must be completely encompassed for it to be selected, progressive feedback 510 may help the user 102 to see how much more of the graphical element 204 he/she needs to encompass for it to be selected. When selection settings are set such that a graphical element 204 may be partially selected for it to be selected, progressive feedback 510 may help the user 102 to see where the selection boundary 208 may be touching graphical elements 204 that he/she does not intend to select.

According to embodiments, providing visual feedback of selection of a graphical element prior to commitment of the selection may include displaying a graphical element's 204 bounding box 512 as a user 102 is performing a lasso selection of the graphical element 204T as illustrated in FIG. 5B. As the user 102 is dragging a selection boundary 208 around the graphical element 204T, he/she may be better able to ensure he/she is selecting the graphical element 204T he/she is trying to select because, when selection settings are set such that a graphical element 204 must be completely encompassed for it to be selected, the user is able to see and verify that the graphical element's 204T bounding box 512 is encompassed within the selection boundary 208. When selection settings are set such that a graphical element 204 may be partially selected for it to be selected, the user 102 may be better able to ensure he/she is not selecting graphical elements 204 he/she does not intent to by being able to see that the selection boundary 208 is not overlapping with any bounding boxes 512 of graphical elements 204 he/she does not want to select.

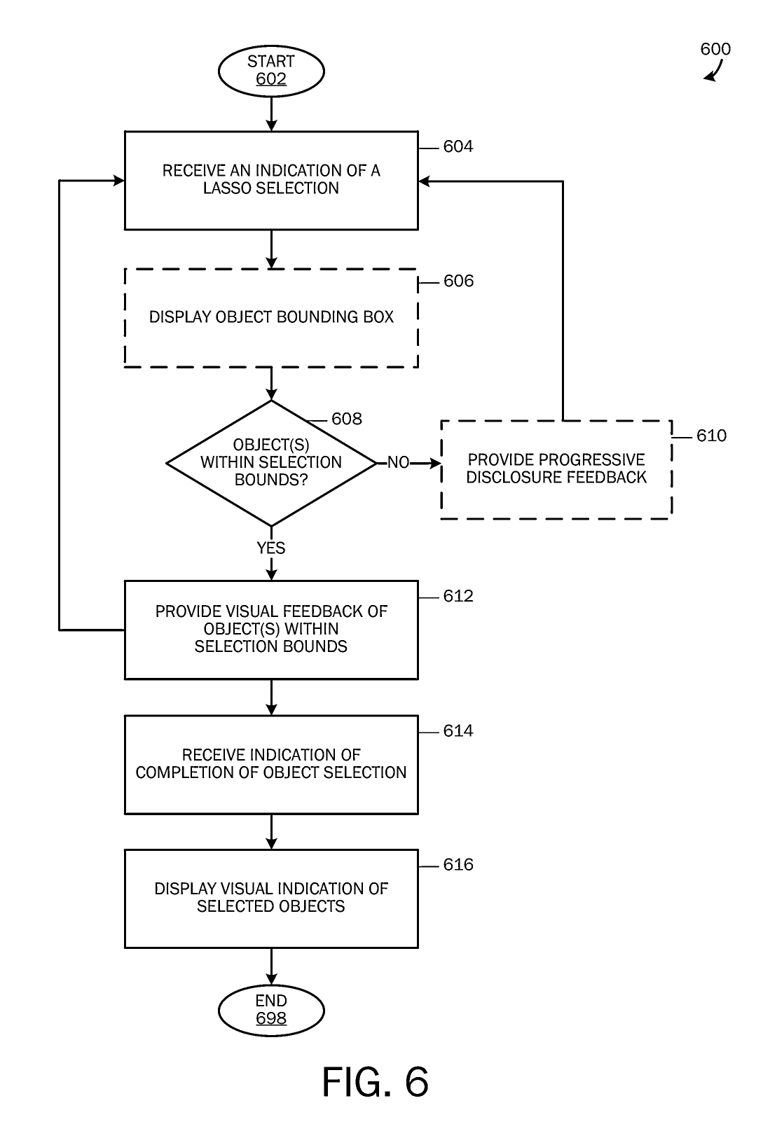

FIG. 6 is a flow chart showing one embodiment of a method 600 for providing visual feedback indicating that a graphical element 204 is included in a selection boundary 208 prior to a commitment of a selection. The method 600 starts at OPERATION 602 and proceeds to OPERATION 604 where an indication of a lasso selection is received. As described above, a lasso selection may comprise drawing a selection boundary 208 around a graphical element 204 or a plurality of graphical elements he/she wishes to select. The selection boundary 208 may be drawn via a variety of methods. For example, if a user 102 is utilizing a pointing device such as a mouse, he/she may place the pointer 206 above and to the left of the graphical element(s) 204 he/she wants to select, and then drag to create a selection boundary 208 around the graphical element(s) 204.

The method 600 may optionally proceed to OPERATION 606, where a bounding box 512 of a graphical element 204 may be displayed. As described above in the description associated with FIG. 5B, displaying a graphical element's 204 bounding box 512 may help a user 102 to see what area he/she may need to include within his lasso selection to select the graphical element 204, or alternatively, to see what areas he/she may need to circumvent to avoid selecting a graphical element 204 he/she does not wish to select.

The method 600 may proceed to DECISION OPERATION 608, where a determination may be made as to whether there is a graphical element 204 within the selection boundary 208. Determining whether a graphical element 204 is within the selection boundary 208 may include determining whether a graphical element 204 is completely within the selection boundary 208 if selection settings are set such that a graphical element 204 must be completely encompassed for it to be selected, or whether part of a graphical element 204 is within the selection boundary 208 if selection settings are set such that a graphical element 204 may be partially within the selection boundary 208 for it to be selected.

If a determination is made that there is not a graphical element 204 within the selection boundary 208, the method 600 may optionally proceed to OPERATION 610, where progressive feedback 510 may be displayed. As described above with respect to FIG. 5A, progressive feedback 510 may include visual feedback to the user 102 as to what portion of a graphical element 204S is currently included in the selection bounds (selection boundary 208). The method 600 may then return to OPERATION 604, where the user 102 continues to perform a lasso selection.

If at DECISION OPERATION 608 a determination is made that a graphical element 204 is within the selection bounds (selection boundary 208), the method 600 may proceed to OPERATION 612, where visual feedback 310 associated with which graphical element(s) 204 are within the selection bounds (selection boundary 208) and will be selected upon commitment of the lasso selection may be displayed. As described, the visual feedback 310 may include various types of feedback including, but not limited to, providing a border or highlighting around selected graphical elements 204, shading or coloring selected graphical elements 204, animating selected graphical elements 204, or providing a text notification 410 indicating a number of graphical elements 204 that will be selected upon commitment of the selection.

The method 600 may return to OPERATION 604, where the user 102 continues to make the lasso selection, or may proceed to OPERATION 614, where an indication of commitment of the lasso selection may be received. For example, commitment of a lasso selection may occur when a user 102 releases a mouse click after a dragging gesture, or when a user 102 lifts his finger or other touch input device from the display surface 126.

After the lasso selection is completed, the method 600 may proceed to OPERATION 616, where a visual indication 210 of the selected graphical elements 204 may be displayed. The selected graphical elements 204 should be the same as the graphical elements 204 shown with visual feedback 310 at OPERATION 612. The user 102 may then perform one of a variety of functionalities with the selected graphical elements 204, such as modification, deletion, copying, or cropping. The method 600 may end at OPERATION 698.

While the invention has been described in the general context of program modules that execute in conjunction with an application program that runs on an operating system on a computer, those skilled in the art will recognize that the invention may also be implemented in combination with other program modules. Generally, program modules include routines, programs, components, data structures, and other types of structures that perform particular tasks or implement particular abstract data types.

The embodiments and functionalities described herein may operate via a multitude of computing systems including, without limitation, desktop computer systems, wired and wireless computing systems, mobile computing systems (e.g., mobile telephones, netbooks, tablet or slate type computers, notebook computers, and laptop computers), hand-held devices, multiprocessor systems, microprocessor-based or programmable consumer electronics, minicomputers, and mainframe computers.

In addition, the embodiments and functionalities described herein may operate over distributed systems (e.g., cloud-based computing systems), where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices. For example user interfaces and information of various types may be displayed and interacted with on a wall surface onto which user interfaces and information of various types are projected. Interaction with the multitude of computing systems with which embodiments of the invention may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

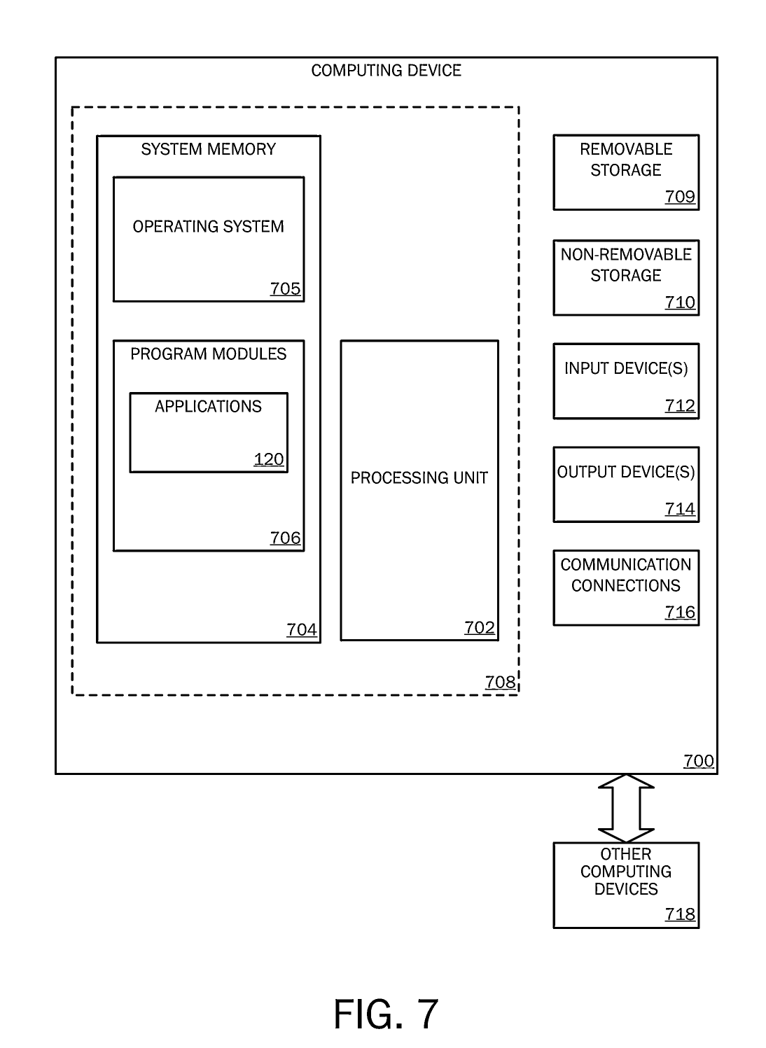

FIGS. 7-9 and the associated descriptions provide a discussion of a variety of operating environments in which embodiments of the invention may be practiced. However, the devices and systems illustrated and discussed with respect to FIGS. 7-9 are for purposes of example and illustration and are not limiting of a vast number of computing device configurations that may be utilized for practicing embodiments of the invention, described herein.

FIG. 7 is a block diagram illustrating physical components (i.e., hardware) of a computing device 700 with which embodiments of the invention may be practiced. The computing device components described below may be suitable for the computing devices described above. In a basic configuration, the computing device 700 may include at least one processing unit 702 and a system memory 704. Depending on the configuration and type of computing device, the system memory 704 may comprise, but is not limited to, volatile storage (e.g., random access memory), non-volatile storage (e.g., read-only memory), flash memory, or any combination of such memories. The system memory 704 may include an operating system 705 and one or more program modules 706 suitable for running software applications 120. The operating system 705, for example, may be suitable for controlling the operation of the computing device 700. Furthermore, embodiments of the invention may be practiced in conjunction with a graphics library, other operating systems, or any other application program and is not limited to any particular application or system. This basic configuration is illustrated in FIG. 7 by those components within a dashed line 708. The computing device 700 may have additional features or functionality. For example, the computing device 700 may also include additional data storage devices (removable and/or non-removable) such as, for example, magnetic disks, optical disks, or tape. Such additional storage is illustrated in FIG. 7 by a removable storage device 709 and a non-removable storage device 710.

As stated above, a number of program modules and data files may be stored in the system memory 704. While executing on the processing unit 702, the program modules 706 may perform processes including, but not limited to, one or more of the stages of the method 600 illustrated in FIG. 6. Other program modules that may be used in accordance with embodiments of the present invention may include applications 120, such as, electronic mail and contacts applications, word processing applications, spreadsheet applications, database applications, slide presentation applications, drawing or computer-aided application programs, etc.

Furthermore, embodiments of the invention may be practiced in an electrical circuit comprising discrete electronic elements, packaged or integrated electronic chips containing logic gates, a circuit utilizing a microprocessor, or on a single chip containing electronic elements or microprocessors. For example, embodiments of the invention may be practiced via a system-on-a-chip (SOC) where each or many of the components illustrated in FIG. 7 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to providing visual feedback indicating that a graphical element is included in a selection boundary prior to a commitment of a selection may be operated via application-specific logic integrated with other components of the computing device 700 on the single integrated circuit (chip). Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

The computing device 700 may also have one or more input device(s) 712 such as a keyboard, a mouse, a pen, a sound input device, a touch input device, etc. The output device(s) 714 such as a display, speakers, a printer, etc. may also be included. The aforementioned devices are examples and others may be used. The computing device 700 may include one or more communication connections 716 allowing communications with other computing devices 718. Examples of suitable communication connections 716 include, but are not limited to, RF transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 704, the removable storage device 709, and the non-removable storage device 710 are all computer storage media examples (i.e., memory storage.) Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 700. Any such computer storage media may be part of the computing device 700. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

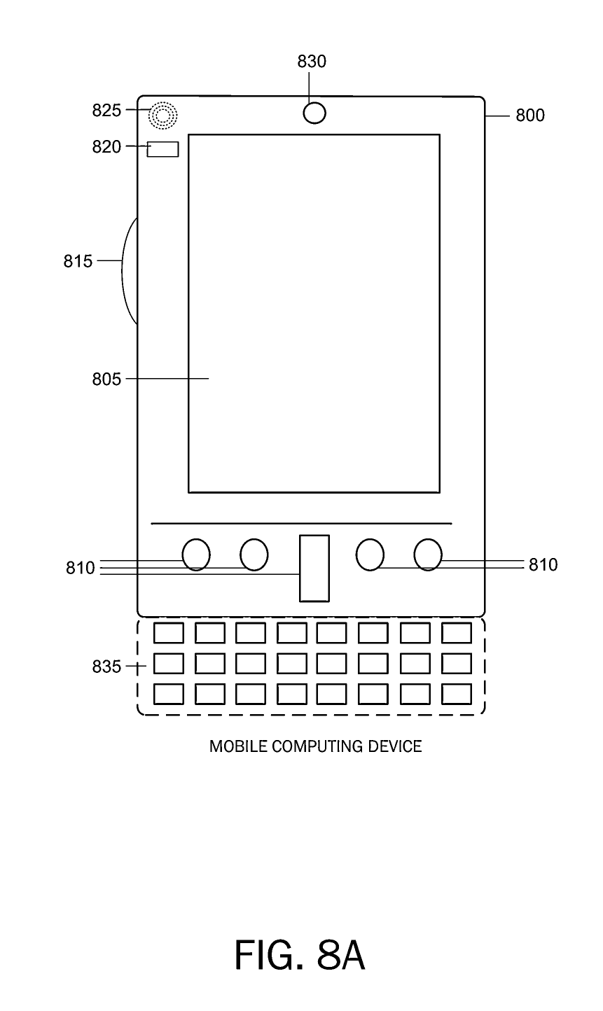

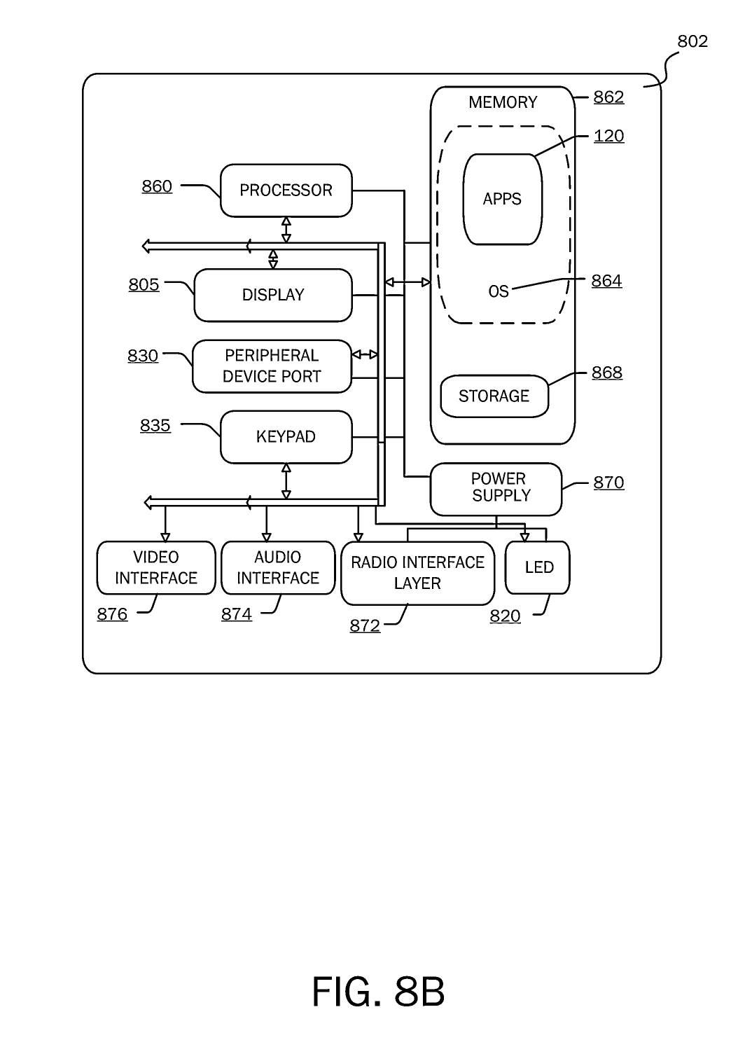

FIGS. 8A and 8B illustrate a mobile computing device 800, for example, a mobile telephone, a smart phone, a tablet personal computer, a laptop computer, and the like, with which embodiments of the invention may be practiced. With reference to FIG. 8A, one embodiment of a mobile computing device 800 for implementing the embodiments is illustrated. In a basic configuration, the mobile computing device 800 is a handheld computer having both input elements and output elements. The mobile computing device 800 typically includes a display 805 and one or more input buttons 810 that allow the user to enter information into the mobile computing device 800. The display 805 of the mobile computing device 800 may also function as an input device (e.g., a touch screen display). If included, an optional side input element 815 allows further user input. The side input element 815 may be a rotary switch, a button, or any other type of manual input element. In alternative embodiments, mobile computing device 800 may incorporate more or less input elements. For example, the display 805 may not be a touch screen in some embodiments. In yet another alternative embodiment, the mobile computing device 800 is a portable phone system, such as a cellular phone. The mobile computing device 800 may also include an optional keypad 835. Optional keypad 835 may be a physical keypad or a “soft” keypad generated on the touch screen display. In various embodiments, the output elements include the display 805 for showing a graphical user interface (GUI), a visual indicator 820 (e.g., a light emitting diode), and/or an audio transducer 825 (e.g., a speaker). In some embodiments, the mobile computing device 800 incorporates a vibration transducer for providing the user with tactile feedback. In yet another embodiment, the mobile computing device 800 incorporates input and/or output ports, such as an audio input (e.g., a microphone jack), an audio output (e.g., a headphone jack), and a video output (e.g., a HDMI port) for sending signals to or receiving signals from an external device.

FIG. 8B is a block diagram illustrating the architecture of one embodiment of a mobile computing device. That is, the mobile computing device 800 can incorporate a system (i.e., an architecture) 802 to implement some embodiments. In one embodiment, the system 802 is implemented as a “smart phone” capable of running one or more applications (e.g., browser, e-mail, calendaring, contact managers, messaging clients, games, and media clients/players). In some embodiments, the system 802 is integrated as a computing device, such as an integrated personal digital assistant (PDA) and wireless phone.

One or more application programs 120 may be loaded into the memory 862 and run on or in association with the operating system 864. Examples of the application programs include phone dialer programs, e-mail programs, personal information management (PIM) programs, word processing programs, spreadsheet programs, Internet browser programs, messaging programs, and so forth. The system 802 also includes a non-volatile storage area 868 within the memory 862. The non-volatile storage area 868 may be used to store persistent information that should not be lost if the system 802 is powered down. The application programs 120 may use and store information in the non-volatile storage area 868, such as e-mail or other messages used by an e-mail application, and the like. A synchronization application (not shown) also resides on the system 802 and is programmed to interact with a corresponding synchronization application resident on a host computer to keep the information stored in the non-volatile storage area 868 synchronized with corresponding information stored at the host computer. As should be appreciated, other applications may be loaded into the memory 862 and run on the mobile computing device 800.

The system 802 has a power supply 870, which may be implemented as one or more batteries. The power supply 870 might further include an external power source, such as an AC adapter or a powered docking cradle that supplements or recharges the batteries.

The system 802 may also include a radio 872 that performs the function of transmitting and receiving radio frequency communications. The radio 872 facilitates wireless connectivity between the system 802 and the “outside world,” via a communications carrier or service provider. Transmissions to and from the radio 872 are conducted under control of the operating system 864. In other words, communications received by the radio 872 may be disseminated to the application programs 120 via the operating system 864, and vice versa.

The visual indicator 820 may be used to provide visual notifications and/or an audio interface 874 may be used for producing audible notifications via the audio transducer 825. In the illustrated embodiment, the visual indicator 820 is a light emitting diode (LED) and the audio transducer 825 is a speaker. These devices may be directly coupled to the power supply 870 so that when activated, they remain on for a duration dictated by the notification mechanism even though the processor 860 and other components might shut down for conserving battery power. The LED may be programmed to remain on indefinitely until the user takes action to indicate the powered-on status of the device. The audio interface 874 is used to provide audible signals to and receive audible signals from the user. For example, in addition to being coupled to the audio transducer 825, the audio interface 874 may also be coupled to a microphone to receive audible input, such as to facilitate a telephone conversation. In accordance with embodiments of the present invention, the microphone may also serve as an audio sensor to facilitate control of notifications, as will be described below. The system 802 may further include a video interface 876 that enables an operation of an on-board camera 830 to record still images, video stream, and the like.

A mobile computing device 800 implementing the system 802 may have additional features or functionality. For example, the mobile computing device 800 may also include additional data storage devices (removable and/or non-removable) such as, magnetic disks, optical disks, or tape. Such additional storage is illustrated in FIG. 8B by the non-volatile storage area 868.

Data/information generated or captured by the mobile computing device 800 and stored via the system 802 may be stored locally on the mobile computing device 800, as described above, or the data may be stored on any number of storage media that may be accessed by the device via the radio 872 or via a wired connection between the mobile computing device 800 and a separate computing device associated with the mobile computing device 800, for example, a server computer in a distributed computing network, such as the Internet. As should be appreciated such data/information may be accessed via the mobile computing device 800 via the radio 872 or via a distributed computing network. Similarly, such data/information may be readily transferred between computing devices for storage and use according to well-known data/information transfer and storage means, including electronic mail and collaborative data/information sharing systems.

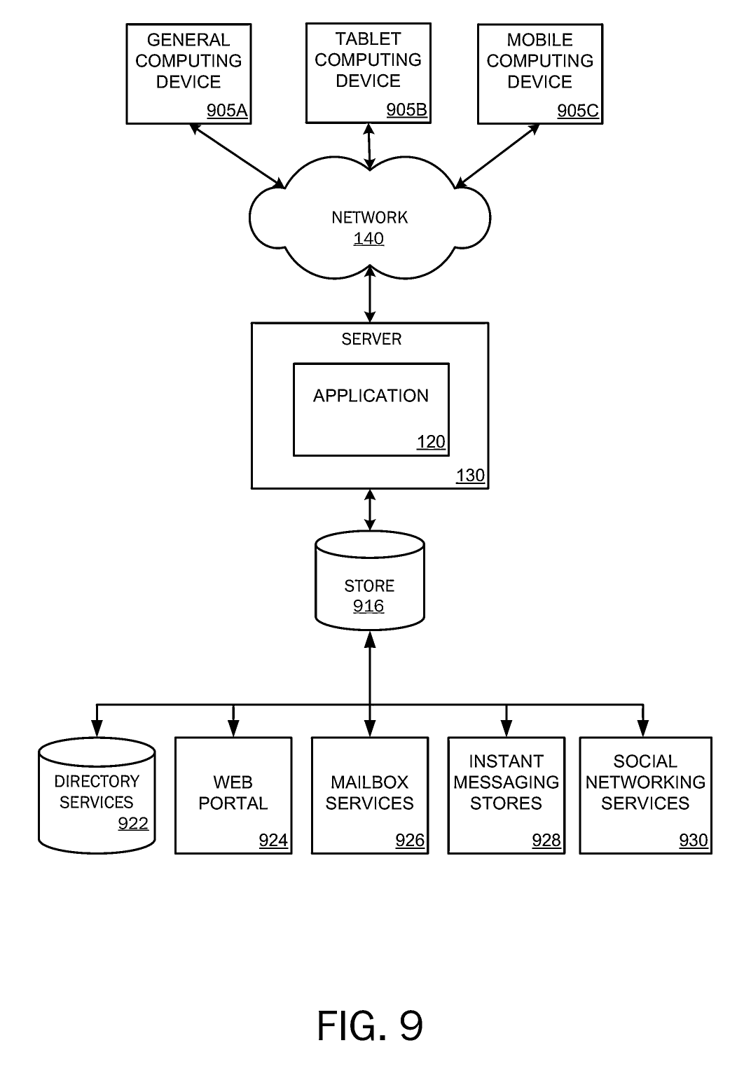

FIG. 9 illustrates one embodiment of the architecture of a system for providing an improved dynamic user interface, as described above. Content developed, interacted with, or edited in association with an application 120 may be stored in different communication channels or other storage types. For example, various documents may be stored using a directory service 922, a web portal 924, a mailbox service 926, an instant messaging store 928, or a social networking site 930. The application 120 may use any of these types of systems or the like for enabling data utilization, as described herein. A server 130 may provide the application 120 to clients. As one example, the server 130 may be a web server providing the application 120 over the web. The server 130 may provide the application 120 over the web to clients through a network 140. By way of example, the client computing device may be implemented and embodied in a personal computer 905A, a tablet computing device 905B and/or a mobile computing device 905C (e.g., a smart phone), or other computing device 110. Any of these embodiments of the client computing device 905A, 905B, 905C, 110 may obtain content from the store 916.

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more embodiments provided in this application are not intended to limit or restrict the scope of the invention as claimed in any way. The embodiments, examples, and details provided in this application are considered sufficient to convey possession and enable others to make and use the best mode of claimed invention. The claimed invention should not be construed as being limited to any embodiment, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate embodiments falling within the spirit of the broader aspects of the general inventive concept embodied in this application that do not depart from the broader scope of the claimed invention.

We claim:

1. A method for providing an indication that a graphical element is included in a selection boundary prior to a commitment of a selection, the method comprising:
displaying one or more graphical elements in a graphical user interface on a display surface;
receiving an indication of a selection at a first point on a display surface;
receiving an indication of a drag gesture on the display surface over or around at least a portion of one or more of the displayed graphical elements;
in response to the selection at the first point and the drag gesture on the display surface over or around at least a portion of one or more of the displayed graphical elements, displaying a selection boundary around an area bounded by the selection and drag gesture;
determining that a graphical element is within the selection boundary; and
in response to the determination, displaying visual feedback associated with the graphical element indicating that the graphical element is included in the selection boundary.

2. The method of claim 1, wherein determining that a graphical element is within the selection boundary comprises determining that a bounding box of the graphical element is inside the selection boundary.

3. The method of claim 1, wherein determining that a graphical element is within the selection boundary comprises determining that a portion of a bounding box of the graphical element is inside the selection boundary.

4. The method of claim 1, wherein displaying visual feedback associated with the graphical element indicating that the graphical element is included in the selection boundary comprises displaying one or more of:
a border around the graphical element;
highlighting around the graphical element;
shading on the graphical element;
animation of the graphical element;
an indication of a number of selected graphical elements; or
an indication of progressive disclosure of selection of a graphical element.

5. The method of claim 4, wherein displaying an indication of progressive disclosure of selection of a graphical element comprises displaying an indication of a portion of the graphical element that is inside the selection boundary.

6. The method of claim 1, further comprising in response to the selection at the first point and the drag gesture on the display surface over or around one or more of the displayed graphical elements, displaying a bounding box of the graphical element.

7. The method of claim 1, wherein displaying one or more graphical elements in a graphical user interface on a display surface comprises displaying a plurality of graphical elements that are combined into a group.

8. The method of claim 7, further comprising:
receiving an indication of a selection at a first point on a display surface;
receiving an indication of a drag gesture on the display surface over or around at least a portion of the graphical elements that are combined into a group;
in response to the selection at the first point and the drag gesture on the display surface over or around at least a portion of the graphical elements that are combined into a group, displaying a selection boundary around an area bounded by the selection and drag gesture;
determining that the group is within the selection boundary; and
in response to the determination, displaying visual feedback associated with the graphical elements that are combined into a group indicating that the graphical elements that are combined into a group are included in the selection boundary.

9. The method of claim 8, further comprising:
determining that at least one graphical element of the graphical elements that are combined into a group is not included in the selection boundary; and
displaying an indication of which graphical elements the group is comprised.

10. A system for providing an indication that a graphical element is included in a selection boundary prior to a commitment of a selection, the system comprising:
one or more processors; and
a memory coupled to the one or more processors, the one or more processors operable to:
display one or more graphical elements in a graphical user interface on a display surface;
receive an indication of a selection at a first point on a display surface;
receive an indication of a drag gesture on the display surface over or around at least a portion of one or more of the displayed graphical elements;
in response to the selection at the first point and the drag gesture on the display surface over or around at least a portion of one or more of the displayed graphical elements, display a selection boundary around an area bounded by the selection and drag gesture;
determine that a graphical element is within the selection boundary; and
in response to the determination, display visual feedback associated with the graphical element indicating that the graphical element is included in the selection boundary.

11. The system of claim 10, wherein the one or more processors, in determining that a graphical element is within the selection boundary, are further operable to determine that a bounding box of the graphical element is inside the selection boundary.

12. The system of claim 10, wherein the one or more processors, in determining that a graphical element is within the selection boundary, are further operable to determine that a portion of a bounding box of the graphical element is inside the selection boundary.

13. The system of claim 10, the visual feedback associated with the graphical element indicating that the graphical element is included in the selection boundary comprises one or more of:
a border around the graphical element;
highlighting around the graphical element;
shading on the graphical element;
animation of the graphical element;
an indication of a number of selected graphical elements; or
an indication of progressive disclosure of selection of a graphical element.

14. The system of claim 13, wherein an indication of progressive disclosure of selection of a graphical element comprises an indication of a portion of the graphical element that is inside the selection boundary.

15. The system of claim 10, wherein the one or more processors are further operable to, in response to the selection at the first point and the drag gesture on the display surface over or around one or more of the displayed graphical elements, display a bounding box of the graphical element.

16. The system of claim 10, wherein the one or more processors, in displaying one or more graphical elements in a graphical user interface on a display surface, are further operable to:
display a plurality of graphical elements that are combined into a group;
receive an indication of a selection at a first point on a display surface;
receive an indication of a drag gesture on the display surface over or around at least a portion of the graphical elements that are combined into a group;
in response to the selection at the first point and the drag gesture on the display surface over or around at least a portion of the graphical elements that are combined into a group, display a selection boundary around an area bounded by the selection and drag gesture;
determine whether the group is within the selection boundary;
if a determination is made that the group is within the selection boundary, display visual feedback associated with the graphical elements that are combined into a group indicating that the graphical elements that are combined into a group are included in the selection boundary; and
if a determination is made that at least one graphical element of the graphical elements that are combined into a group is not included in the selection boundary, display an indication of which graphical elements the group is comprised.

17. A computer readable medium containing computer executable instructions which, when executed by a computer, perform a method for providing an indication that a graphical element is included in a selection boundary prior to a commitment of a selection, the method comprising:
displaying one or more graphical elements in a graphical user interface on a display surface;
receiving an indication of a selection at a first point on a display surface;
receiving an indication of a drag gesture on the display surface over or around at least a portion of one or more of the displayed graphical elements;
in response to the selection at the first point and the drag gesture on the display surface over or around at least a portion of one or more of the displayed graphical elements, displaying a selection boundary around an area bounded by the selection and drag gesture;
determining that a graphical element is within the selection boundary; and
in response to the determination, displaying visual feedback associated with the graphical element indicating that the graphical element is included in the selection boundary.

18. The computer readable medium of claim 17, wherein displaying visual feedback associated with the graphical element indicating that the graphical element is included in the selection boundary comprises displaying one or more of:
a border around the graphical element;
highlighting around the graphical element;
shading on the graphical element;
animation of the graphical element;
an indication of a number of selected graphical elements; or
an indication of progressive disclosure of selection of a graphical element.

19. The computer readable medium of claim 17, further comprising in response to the selection at the first point and the drag gesture on the display surface over or around one or more of the displayed graphical elements, displaying a bounding box of the graphical element.

20. The computer readable medium of claim 17, further comprising:
displaying a plurality of graphical elements that are combined into a group;
receiving an indication of a selection at a first point on a display surface;
receiving an indication of a drag gesture on the display surface over or around at least a portion of the graphical elements that are combined into a group;
in response to the selection at the first point and the drag gesture on the display surface over or around at least a portion of the graphical elements that are combined into a group, displaying a selection boundary around an area bounded by the selection and drag gesture;
determining whether the group is within the selection boundary;
if a determination is made that the group is within the selection boundary, displaying visual feedback associated with the graphical elements that are combined into a group indicating that the graphical elements that are combined into a group are included in the selection boundary; and
if a determination is made that at least one graphical element of the graphical elements that are combined into a group is not included in the selection boundary, displaying an indication of which graphical elements the group is comprised.
